(19) United States
(12) Patent Application Publication
(10) Pub. No.: US 2003/0120539 A1
(43) Pub. Date: Jun. 26, 2003

(54) System for monitoring and analyzing the performance of information systems and their impact on business processes

(76) Inventors: Nicolas Kourim, Nanterre Cedex (FR); Sylvain Quartier, Paris (FR); Xavier Barny de Romanet, London (GB); Oscar Jager, London (GB)

Correspondence Address: Thomas M. Freiburger, 29th Floor, 650 California St., San Francisco, CA, 94108, US

(21) Appl. No.: 10/036,266

(22) Filed: Dec. 24, 2001

(51) Int. Cl. G06F 17/60

(52) U.S. Cl. 705/11; 705/7

(57) ABSTRACT

A system for monitoring, analyzing and improving information systems which serve critical areas of business concerns includes a review of a concern's business processes, with identification of at least one critical business process of the concern, followed by identification of elements of information systems structure of the concern that support of affect each identified critical business process of the concern. Once this has been done, equipment is deployed at the client concern, including necessary software on and off the client site as needed to collect and monitor data from the identified information systems elements. The equipment is connected to an on-site server. Parameters are set as to what data will be collected and the manner in which data will be collected from the identified elements, then data are collected from the pre-identified points in the information system's structure. These data are transferred from the on-site server to an off-site data warehouse, then processed in accordance with preselected metrics to create metadata regarding the client concern. Finally, the data are rendered, formatted in a preselected manner and forwarded to the concern, preferably with reports to the client concern as to performance of the monitored information elements and the affected business processes, and including recommendations for improving the information system's structure and its performance.

### BACKGROUND OF THE INVENTION

This invention concerns business information systems, often referred to as “information technology” or “IT”, supporting a business process, and a system and method for monitoring, analyzing and improving such information systems regarding their performance and their impact on business processes by monitoring and appraising critical elements or components and areas of such information systems and business processes so as to collect data and identify poor performance or inefficiencies and their causes so as to facilitate improvement in the contribution of IT to business processes' performance and results.

Information systems, including telecommunications, computer networks, servers, applications and other elements, are essential degree of automation in their business processes and that generate or handle a significant amount of business transactions supported by IT. Business processes, including the end users using the information systems, business transactions, and the end results of such transactions such as units produced, are a company's operational and organizational core elements that allow it to do effective business. The information systems rely on a variety of components or elements and areas or providers, often large in number, some of which are internal to the business and some of which are external, provided by service providers, exist in this context. Two main problem areas exist in this context: a) the complexity of the information systems and the quantity of the elements they contain often results in one or several of these components or elements and areas or providers of the overall information system not performing as expected or as promised, or not interacting with one or more other components or elements and areas or providers in an efficient manner, leading to a specific overall level of performance of the IT supporting the business which can be different than expected or unstable, b) information systems are still managed by technical functions such as servers (data centers), networks (LAN, WAN), decentralized equipment (PC's), applications, and others. Performance is improved by measuring each function independently as to its “production capacity” and by optimizing reaction and repair time after the failure of specific elements, Current systems do generally not take into account the overall performance of cross-functional elements for the delivery of an overall service into specific businesses and their processes. This leads to an incapacity to adapt IT concretely and constantly to the specific needs of businesses and and to “predict” the behaviour of complex IT in regards to the business the serve.

It is a primary objective of the invention described herein to monitor, identify measure and analyze such non-performing components or elements and areas or providers and their impact on business processes through identification of critical business processes and critical business system components, elements, areas, or providers serving such processes, and evaluation of the performance of such critical components, elements, areas, or providers and their impact on business processes and results.

The following U.S. Pat. Nos. may have some relevance to this invention: 6,275,977, 6,256,676, 6,249,768, 6,237,020, 6,219,654, 6,208,345, 6,170,011, 6,167,448, 5,958,012, 5,913,061, and 5,890,132.

### SUMMARY OF THE INVENTION

In accordance with a preferred embodiment of the invention, a method and system are provided for monitoring, analyzing, and improving information systems as they affect the functioning, productivity and cost of business processes for a business concern that are dependent on information systems for managing said business processes. The method includes reviewing the business processes of the concern and identifying at least one critical business process, usually several such critical business processes; then identifying the specific users of IT in said business processes, then identifying the components, elements, areas or providers of the existing information system's structure, that specifically support or affect said critical business processes and its users, then identifying the relationship between said components, elements, areas or providers..

Equipment is then deployed, on the client concern's site, as needed to collect and monitor data from the identified information systems components, elements, areas or providers, as well as from the users of said IT in said critical business processes. On-site equipment is connected to the concern's information systems infrastructure. Parameters are set on this equipment as to the manner in which data will be collected and as to what data will be collected.

Once such equipment as been deployed, data are collected from pre-identified points in the identified business systems components, elements or areas in the information system structure.

These collected data are then transferred to, either on-site or off-site the client concern's site, a data warehouse in a preferred embodiment.

Using the data warehouse, the collected data are aggregated and analyzed to create metadata regarding the information systems of the client concern. The data are then rendered, formatted in a preselected manner for the concern, and the rendered data are then forwarded to the concern.

To build the relationship between the business processes performance and the performance of the information system, and to determine how the information system contributes to the business processes performance, data collected from the end users of the business processes are aggregated in the data warehouse regarding the providers used by end users, area used by end users, components and elements used by end users and the overall performance of the information system received by the end user that enable him to generate the business transactions related to the business processes. The data warehouse can be on-site or off the client concern's site.

Reports are created and delivered to the client concern as to performance of the monitored information systems components, elements, areas or providers and the affected business processes and their users, including recommendations for improving such components, elements, areas or providers and their performance.

In one preferred implementation, the rendered data are formatted in such a way as to be interest to different management personnel or staff inside the client concern or outside the client concern (supplier, customer, partner), and are available via the Internet or other network. Thus, each concerned management individual can log in with an appropriate password, so as to be able to access the rendered data conveniently, when needed.

Another important feature in some implementations of the system is to maintain a data base of performance standards derived from other businesses which have been served by the system of the invention, so as to make comparisons of the performance of various IT components from one client concern to another thereby providing an additional source of indicators as to performance level of such components or business processes supported by IT. As one example, if several airlines have been represented by the inventive system, various sectors of the information systems of one client concern can be compared and evaluated against the same type sector of one or several other concerns, particularly those that have been verified to be operating efficiently, or similar technical configurations across different sectors can be compared and evaluated.

Another feature of the system is to evaluate the collected data by comparing actual performance to service level agreements (SLA) of outside or internal service providers contacting with the client concern.

Preferably the system and method are divided into two parts. The first involves reviewing business processes of the concern and identifying critical business processes, then identifying elements, components, areas and providers and relationship among elements, components, areas and providers in the existing information systems structure that support or affect each identified critical business process. After this is complete, the client concern is presented with a document identifying all of these processes, elements, components, areas and providers and relationships, and this document can be called an Enterprise Service Level Management Analysis (ESLMA). This analysis is followed by a Business to IT solution implementation able to manage the Business to IT Quality of Service (B-IT QoS). The ESLMA describes how the inventive system will determine how the information systems impact the business processes running quality, its productivity and its cost.

The second part of the system is the actual deployment of equipment followed by the monitoring and analysis and rendering steps as described above.

A schematic diagram, in block diagram format, showing a relationship among providers, information technology departments, and responsible parties within a company of which may need the services of the invention.

It is among the objects of the invention to improve performance of information systems through a system and method that identify and then monitor IT elements, components, areas or providers regarding their roles and their impact on the business processes performance and results, collecting data and comparing performance to various benchmarks or promised service levels. These and other objects, advantages, features of the invention will be apparent from the following description of preferred embodiments.

### DESCRIPTION OF THE DRAWINGS

FIG. 1 is a schematic block diagram showing IT departments, providers, and flow of responsibility within a business.

FIG. 2 is a schematic representation showing information technology components within a business.

FIG. 3 is a similar schematic view, but showing business processes and elements identified and segregated, to identify and collect data.

FIG. 4 is another similar schematic view, indicating deployment of equipment at the business concern site, as needed to collect data from identified sources.

FIG. 5 is another similar schematic view, indicating collection of data and transfer to a data warehouse.

FIG. 6 is a similar schematic view, in this case showing the creation of reports which are delivered to the client concern.

FIG. 7 is a schematic diagram in the form of flow chart showing visibility process work flow.

### DESCRIPTION OF PREFERRED EMBODIMENTS

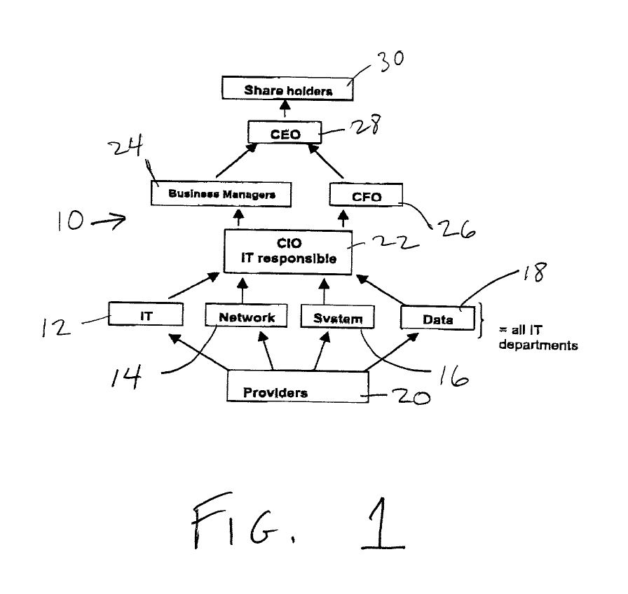

In the drawings, FIG. 1 shows in a block diagram type format the flow of responsibility regarding information technology within a business, including outside providers. The business is generally indicated 10.

As shown, the overall system includes IT departments, including IT 12, network 14, system 16 and data 18. Outside providers 20 supply all of these departments. The chief information officer or CIO 22 is responsible for proper function and efficient and cost effective use of the IT systems. The CIO is responsible to the business managers 24 in terms of performance and availability, and most must control the performance of the entire IT department, here shown as linked to providers 20. Indirectly the CIO has responsibility through the business managers and the CFO 26 to the CEO 28, who is responsible to the shareholders 30.

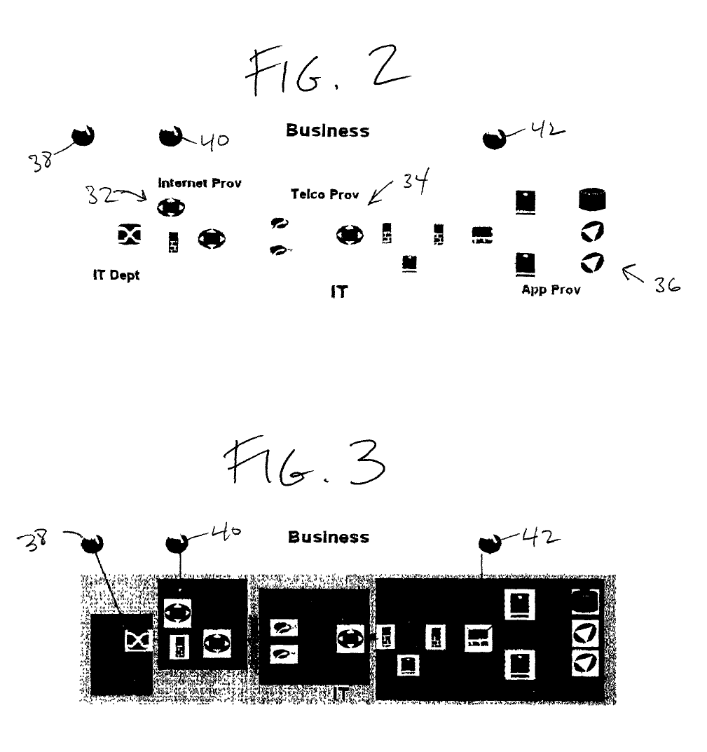

FIG. 2 schematically indicates IT components within a business, particularly in the situation where much of the IT provided by outside providers. As examples, an internet provider and its services are indicated at 32, at telephone communication provider and its services are indicated at 34, and applications provider (e.g. software) are shown at 36. As indicated each of these providers and their services involve a number of different components. The business processes which they serve are schematically indicated above at 38, 40 and 42 in FIG. 2.

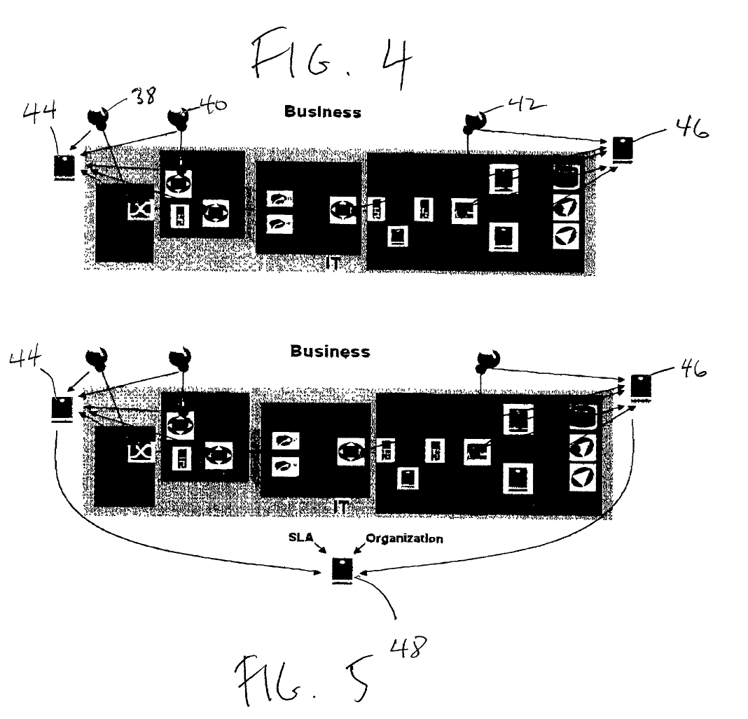

FIG. 3. indicates the process of the invention as regards identification of critical business processes, components or elements and implementation of the enterprise service level management analyzes (eslma) discussed above. Business processes are business process 38, 40 and 42 are identified, and components, elements or areas, shown in the boxes in FIG. 3, are identified and linked to the businesses processes they serve. The identified components or elements of the IT system are instrumented to render performance information of these various components or elements.

Then, as indicated in FIG. 4, equipment is deployed on the client concern site, as needed to collect data from identified sources. Equipment is schematically indicated in FIG. 4 at 44 and 46, and the flow of information is indicated by arrows, including from instrumentation associated with the business processes 38, 40 and 42.

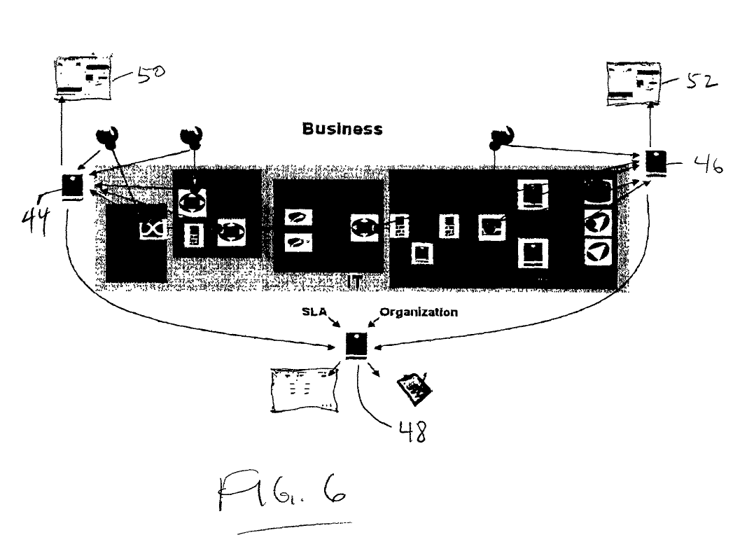

FIG. 5 indicates that the data collected by the equipment 44 and 46 are transferred to a data warehouse, which is indicated at 48. There, the data are aggregated and analyzed to created metadata regarding the information systems' relationship with the critical business processes.

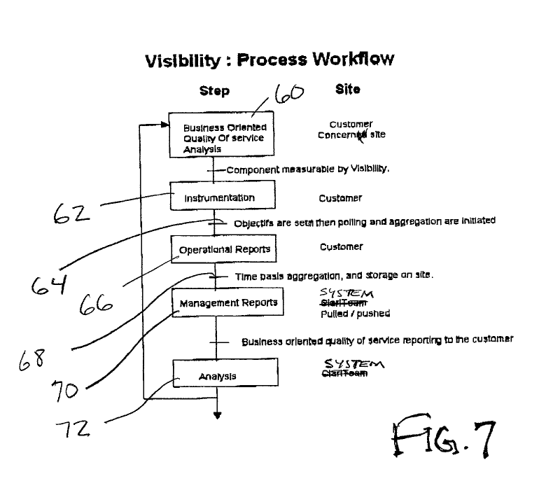

FIG. 6 indicates the generation of reports 50 and 52, which can be delivered to the client concerned via the equipment 44 and 46. The client concern site, can be delivered from the data warehouse 48, or otherwise. FIGS. 5 and 6 also indicate information concerning the organization and service level agreements with providers, is fed to the data warehouse, primary form comparison purposes (e.g., the performance of a particular critical element, such as an element of telephonic communications, is compared to the service level agreement the client concern has with the telephone communication's provider, to determine whether this component is operating as expected and as contracted for.

FIG. 7 schematically shows, in a form of flowchart, the visibility process workflow, from enterprise service level management analyze (as discussed above) to the quality of service analyze phase. The box 60 shows the business oriented quality of service analyze, which occurs at the customer concern site. The system consultant analyzes the IT system of the client concern in regard to the business processes and produces a complete report. Next, as explained above and as represented by the box 62, instrumentation is deployed at the customer site. The system consultant deploys a black box system to measure the IT performance of elements including the end users, relative to the business processes specific metrics.

Next, objectives are set, as noted at 64, and polling and aggregation are initiated. The on-site system collects all data and produces operational reports 66 on quality of services of all relevant IT elements. The diagram indicates time basis aggregation of these reports, and storage on-site, at 68.

The off-site server, usually in the system service center, aggregates the data from customer sites and aggregates IT measurements with end users performance and business processes performance measure, creating management reports 70. Finally, with the measured information, the system is able to provide information analyzes diagnostics, trending, benchmarking and any type of recommendations desired from these areas, indicated in the analyze box 72 in FIG. 7. The following examples are helpful to explain the processes and system of the invention. In example one the client concern is a pipeline installation and maintenance firm, and in example two the client concern is an international airline company. “The system” as used herein refers to the proprietor rendering the services pursuant to the method of the invention.

### EXAMPLE 1

### Pipeline Company

Pipeline & More, Inc., (PLM) is a company that produces, installs, and maintains various kinds of pipeline that transport petroleum products from their customer's offshore drilling platforms to a mainland across the ocean floor. The pipelines are designed and built in France and deployed anywhere they are needed in the world using PLM's fleet of 12 ships.

The laying of pipeline along the ocean floor is a complex task that requires, among other details, the topographical layout and bed relief of the floor of every ocean or sea wherein pipe will be laid. This information, along with other essential details, needs to be accessible to all ships at all times; however, it is not effective or efficient for each ship to maintain a database of the size and complexity necessary to store this information on board. For this reason, PLM decided to set up a central datacenter to house the database and its support personnel. The ships access this database and any information they need for any task via a network of three telecom providers who provide various forms of network access. The use of a global network means that the data can be reached by anyone in the company from anywhere. This information sharing network also has the negative impact of one group's use of the data possibly being a detriment to another group's use of the data. In other words, it is possible that, if one of the ships is querying the database with a complicated request, that request may slow everyone else's access to the database. Another possibility is that, if management is viewing data in France, one of the company's ships may not be able to view data when needed, it consequently destroying their efficiency onsite. In order to measure how the performance of IT may impact any internal division (i.e. project management on the ships, human resources, and finance both in France), PLM can have the system of the invention measure how the performance of PLM's IT affects any and/or all of these divisions. More specifically, the system is called in to measure how one business process's use of PLM's existing IT structure may affect any other business process' use of the same IT resources and how that use may, in turn, affect the overall efficiency of any other business process.

After identifying the three above mentioned business processes (project management, human resources and finance as being their critical processes, PLM will work with a consultant from the system of the invention to pinpoint the information systems elements that those identified business processes rely on. This process creates a charting of relationships between IT and the business processes that rely on the IT. This chart is called the matrix. For example, the project management process discloses that users are on the ships. Users are often a great distance from the database. Each user has access to a personal desktop computer to access the database. Access to the database is accomplished via the network services provided by the three previously mentioned telecommunications companies. Each information services provider has an agreement with PLM called a Service Level Agreement (SLA). This agreement is a contract that defines the level of service that PLM is to receive from that specific provider. Per the terms of the SLA, if the agreed upon level of service is not met, the provider incurs penalties. For example, Telecommunications Company 1 delivers satellite service.

Their SLA with PLM specifies that they will maintain a 99.5% level of availability per month to a channel capable of a maximum of 10 megabits per second (MBPS) of bandwidth with an available burst capacity of 12 MBPS and no less then 8 MBPS at any time. Telecommunications Company 2 delivers network connectivity. Their SLA with PLM promises less than 10 minutes of downtime per month and no greater than a 10 second response time between any two network nodes. Telecommunications Company 3 delivers high speed Internet access to users premises. Their SLA with PLM promises that PLM shall have access to 95% of the capacity of four dedicated links to their datacenter for both inbound and outbound traffic.

PLM houses their database in a datacenter in Scotland run by another company. That company, the Network Operations Center (NOC), has an agreement with its customer's which specifies an availability to their respective databases of at least 99.3% per month. This agreement has not been concluded in writing but has been stated orally. A stated objective to provide a level of service not evidenced by a written contract is called a Service Level Objective (SLO). SLOs are typically found between two divisions inside a company but can, as here, exist between two separate companies. An example of an SLO within two divisions of the same company may work as follows: If the finance department promises to turn out reports of the quarter, within one day after the termination of the quarter, to management, and this agreement is not written down, this is considered an SLO. The system of the invention monitors the true level of compliance with all parties concerned to all of the PLM's SLAs and SLOs. Neither can be ignored to achieve a true picture of that company's relational performance between business processes and IT.

The identification of all of the above relationships is then presented to the user, PLM in this case, in a unique document as described above, called the Enterprise Service Level Management Analysis (ESLMA). This audit is followed by a proposal to implement a business-oriented Service Level Management (SLM) Solution that describes how the system will monitor and identify any type of problems. Then equipment of the systems is deployed on and off PLM's various premises to monitor system performance. In this example, such a rollout of equipment may be as follows:

Software applications will be downloaded to each desktop of each individual computer with direct network access. This includes ships in the field and desktops running in PLM's headquarters in France. These applications will measure network response time, database response time, satellite uplink/downlink throughput and availability, packet loss, etc., as well as local machine processes such as cache hits, bytes read/written per second, processor usage, memory locks, page faults, swap file size, etc. This data is collected by the application, then sent via the network to a server on PLM's premises as noted below.

At this moment, the on-site server is able to produce very technical reports, on the health of all elements in the IT infrastructure that it is capable of collecting data from.

A server located on PLM's premises will receive all the data collected by each application both in the field and in PLM's headquarters. This server acts as an intermediary between the field applications and system's server. It functions to aggregate the collected data before it sends all data to the system's off-site server and to the central data warehouse.

At this point the data are ready to be sent to the data warehouse where the intense processing and report formatting will be performed. The system staff will program the data warehouse with the parameters desired to be measured by the client. These parameters typically mirror the SLAs and/or SLOs of the client, the definition of the business processes and all links existing between a business process and their respective information systems elements.

Then the data are transferred.

At this point the data warehouse is able to prepare targeted reports for individual managers in different departments in PLM. Because each department has different needs from the information systems they depend on, this kind of targeted reporting is essential to judge each business process/information systems element relationship. This kind of complex reporting is only possible after first establishing the aforementioned matrix to describe what business processes are dependant upon what information systems elements. Without at least a rudimentary understanding of these relationships a consulting company could not offer a solution targeted for specific business processes. Such is the benefit of this method.

### EXAMPLE 2

### Airline Company

IAL is an international airlines company. Effective competition in this market necessitates, not only efficient air travel, but also efficiency in ground operations such as boarding, ticketing and check-in at the gates. In order to improve speed at each step in the process, some of these steps have become dependent upon information technologies. Some of these technologies are owned and managed by IAL while others are provided and managed by an external provider. As in the previous example, IAL has an SLA with each external provider that determines the nature of their relationship. IAL also has SLOs, internally, with other divisions of IAL that are responsible for information technologies.

Because not all IT elements are under the control of IAL, the system was hired to judge the viability and success of the SLAs. The system will also judge the success with which the internal divisions of IAL meet their own SLOs.

The first question to be answered for the system is, what processes are critical to ground operations? The second is, what IT elements impact these processes? The answers to these two questions provide the matrix, or the lens through which the system will view the whole of IAL's ground operations and how IT affects them. This lens will be the construct that the ESLMA will be based upon.

An IAL project manager tells the system of four business process that are dependant upon IT, or where IT plays a significant role.

1) The Reservation System—External:

This is the system used by IAL employees to reserve seats on flights for potential IAL customers. This is the principle exposure to IAL for most clients and the competitive success of IAL is obviously heavily related to the efficient performance of this process, and therefore, the systems this process depends upon. This system is hosted and managed by an external provider with a binding SLA in place. The users of this system are the IAL employees themselves.

2) The Reservation System—Internal:

This is a system like the one above. It is an older system that is managed internally by IAL employees and, though IAL is in the middle of outsourcing this system (to the one above) it is still used by some employees who do not have access to the newer outsourced system above.

3) Check In:

This is the step before an individual boards a plane. This is a purely internal system, owned, operated, and used by IAL employees. It is a simple process where an individual already with a ticket confirms his/her seat on the pending flight at the check-in counter or gate. The response time of this system is critical because the system must only ease passengers to the next process (boarding). It cannot hold them up at the check-in counter and make potentially late passengers even more late to the extent that some may miss the plane rolling back only a few short feet away, or risk delaying the plane and losing the takeoff slot while trying to check in all passengers.

4) Boarding Control:

As with the system and IT elements in the check in process, this is a wholly internal process. It is used by gate employees prior to the departure of the plane to check last minute seat availability and confirm the final passenger count for the manifest. Response time is the critical metric for this system as a slow response from the system will actually delay the plane leaving the gate.

For each of the above critical business processes an IAL employee is the user. It is from their perspective that response time and availability of the information system must be measured. IAL has asked the system to collect and compare response times and availability from each system including the outsourced reservation system to evaluate the provider's success in meeting their SLA.

In order to measure the system from the perspective of a user as they interact with the system, it is not sufficient to merely (as in the previous example of the pipeline company) place passive data collection and aggregation servers at various points in the network. Response time needs to be measured as the difference in time between an entered user request and a response from the system. It is not desirous, however, to rely on the user (the IAL employee) in the course of their duties, as the average user does not generate a sufficient number of requests in any given day to produce a statistically significant sample of results for System to measure. As a result, the system has created 30 software agents or “robots”, distributed throughout network. Each robot is designed to perform the same duties as an IAL employee but with greater frequency so System can collect the most data possible from the network in the shortest amount of time.

Though these software agents are responsible for generating the data to be measured, the system still has an on-site server to collect and aggregate the data before sending it to System's off-site server and subsequently the data warehouse.

At this point the data warehouse is able to prepare targeted reports for individual managers in different departments in ILA.

Because each department (and each manager) has different needs from the information systems they depend on, this kind of targeted reporting is essential to judge each business process/information systems element relationship.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

We claim:

1. A method for monitoring, analyzing, and improving information systems as they affect the functioning of business processes for a concern dependent on information systems, comprising:
reviewing business processes and identifying at least one critical business process of the concern,
identifying elements and relationships of elements of existing information systems structure that support or affect each identified critical business process,
deploying equipment including necessary software both on and off the client concern's site as needed to collect and monitor data from said identified information systems elements and connecting the on-site equipment including an on-site server to the concern's information systems structure,
setting parameters as to what data and the manner in which data will be collected from said identified elements, collecting data from pre-identified points comprising said identified elements in the information systems structure, then transferring the collected data from the on-site server to an off-site data warehouse included in the off-site equipment,
using the data warehouse, processing received data in accordance with preselected metrics to create metadata regarding the client concern,
rendering the data, formatted in a preselected manner for the concern and forwarding the rendered data to the concern, and
delivering reports to the client concern as to performance of the monitored information elements and the affected business processes, including recommendations for improving the information systems structure and its performance.

2. The method of claim 1, wherein the rendered data is arranged in such a way as to be of interest to different management personnel in the client concern, and including assigning each different management individual a unique login and password so as to be able to access the rendered data via a wired or wireless network.

3. The method of claim 1, wherein, prior to deploying the equipment on the client concern's site, the method further includes presenting to the client concern a proposal as to deployment of equipment and software and identification of what data will be collected and monitored.

4. The method of claim 1, wherein the collected an processed data from the client concern are compared to data taken from other or previous clients in similar businesses for the purpose of determining relative efficiency levels of processes and elements in the client concern.

5. The method of claim 1, further including following the collection and processing of the data, evaluating existing service level agreements and service level objectives of the client concern to determine whether the client concern is receiving service levels from third party providers as required by such agreements and objectives.

6. The method of claim 1, further including the step of analyzing the collected data to determine an optimum service level agreement for a particular third party provider of services, in the event no such service level agreement is existing.
